(19) United States
(12) Patent Application Publication
(10) Pub. No.: US 2010/0059340 A1
(43) Pub. Date: Mar. 11, 2010

(54) Rolling conveyor with a separate drive assembly

(76) Inventors: Marco Willi, Benningen am Neckar (DE); Volker Porzer, Baltmannsweiler (DE); Hans-Peter Buttau, Lauffen (DE); Peter Ludwig, Tuebingen (DE); Peter Ulmer, Urbach (DE)

Correspondence Address: Striekr, Striker & Stenby, 103 East Neck Road, Huntington, NY, 11743, US

(21) Appl. No.: 12/422,495

(22) Filed: Apr. 13, 2009

(30) Foreign Application Priority Data
Sep. 10, 2008 (DE) 102008046519.4

(51) Int. Cl. B65G 13/06

(52) U.S. Cl. 198/781.01

(57) ABSTRACT

A rolling conveyor has a frame on which a plurality of feed rollers that define a conveyor surface are rotatably supported, at least some of the feed rollers each have a first drive wheel, which is in rotary drive communication with a second drive wheel, the second drive wheels are located on a rotatable drive shaft with which they are each in rotary drive communication via a respective slip clutch, at least one and preferably all the second drive wheels and the associated slip clutch are combined each into a separate drive assembly that can be installed as a unit, the drive assembly is supported rotatably on the frame, and the drive shaft is received in the drive assembly in a manner fixed against relative rotation and preferably longitudinally displaceably.

### CROSS-REFERENCE TO RELATED APPLICATIONS

The invention described and claimed hereinbelow is also described in German Patent Applications DE 10 2008 046 519.4 filed on Sep. 10, 2008. This German Patent Applications, whose subject matter is incorporated here by reference, provides the basis for a claim of priority of invention under 35 U.S.C. 119(a)-(d).

### BACKGROUND OF THE INVENTION

From European Patent Disclosure EP 129 911 B1, a rolling conveyor is known. According to FIG. 2 of EP 129 911 B1, the rolling conveyor includes a frame 42, on which a plurality of feed rollers 12 that define a conveyor surface are supported rotatably via the rotary bearing 46. At each feed roller, a first drive wheel in the form of a bevel gear wheel 18 is provided, which is in rotary drive communication with a second drive wheel 20, likewise embodied as a bevel gear wheel. The second drive wheels of the various feed rollers are located on a common drive shaft (reference numeral 48 in FIG. 1 of EP 129 911 B1), which is rotatably supported on the frame by means of the rotary bearings 44. A slip clutch 30; 32; 34 is also provided, by way of which the second drive wheels are in rotary drive communication with the drive shaft. With this slip clutch, it is to be attained that the product being conveyed can be stopped, even with the drive shaft rotating, for instance using a separator, without causing slip between the feed roller and the product being conveyed that could result in damage to the product. Instead, the slip occurs within the slip clutch, which is designed from the outset such that it can withstand that amount of slip over a long period of time.

Within the scope of the present invention, the term slip clutch should be understood to mean a clutch which transmits torque and in which, until a predetermined limit torque is reached, a substantially slip-free transmission of torque takes place, while upon attaining the limit torque, slip occurs, so that the predetermined limit torque is essentially never exceeded. In the simplest case, as known from EP 129 911 B1, such slip clutches are implemented by using utilizing frictional forces. In this case, the second drive wheel is received rotatably on the drive shaft and is urged by a spring 32 against a stop 24 that is fixedly mounted on the drive shaft. The result of the spring force is a defined limit torque, at which the transition from static friction to sliding friction takes place between the second drive wheel and the associated stop. Still other functional principles for implementing slip clutches, such as the utilization of magnetic forces, are also known in the prior art.

The disadvantage of the conveyor in EP 129 911 B1 is that the installation is quite complicated, since the position of the stops for the second drive wheel must be set in a very complex way. It is also very inconvenient to change the second drive wheel after damage has occurred or the end of the wear-dictated service life, since the entire drive shaft assembly has to be removed and dismantled for the purpose. In this removal operation, the settings of all the limit torques of the slip clutches are also lost and have to be reset again later. The rotary support of the drive shaft is also quite complicated, since a separate rotary bearing is provided at each bearing point. Quite a large number of these rotary bearings is necessary to assure an optimal gear wheel meshing at each feed roller and thus to assure low-noise and low-wear gear wheel meshing. The reason for this is the high flexibility of the comparatively thin drive shaft, which at even low drive forces can lead to a mispositioning of the bevel gear wheels if their spacing from the rotary bearings is great.

### SUMMARY OF THE INVENTION

In accordance with the present invention, it is proposed that at least one and preferably all the second drive wheels and the associated slip clutch are combined each into a separate drive assembly that can be installed as a unit, and the drive assembly is supported rotatably on the frame, and the drive shaft is received in the drive assembly in a manner fixed against relative rotation and preferably longitudinally displaceably.

As a result of the rotary support of the drive assembly directly on the frame, its position relative to the associated feed roller is fixedly specified, so that a complicated setting procedure for orientating the drive wheels can be dispensed with. A further consequence of the support of the drive assembly is that in the immediate of each second drive wheel, a rotary bearing is provided, so that mispositioining due to elasticity between the first and second drive wheel can be precluded. Furthermore, it is not necessary for the drive shaft itself also to be provided with rotary bearings, and its installation and removal are thus simplified.

Moreover, the limit torque of the slip clutch can already be set to an appropriate value during the production of the drive assembly, so that when the conveyor is later installed at the setup location, work time is saved. Because the drive shaft is received longitudinally displaceably in the drive assembly, it can be removed quite simply by being pulled out of the associated bearing assemblies. After that, all the drive assemblies, for instance in the event of wear, can simply be replaced. Later, the drive shaft merely has to be pushed back into the desired position inside the drive assemblies, without requiring further orientation steps. At this point, it should be noted that the installation position of the drive shaft can certainly be assured using detachable positioning means, such as securing disks. If longitudinal displaceability is required, it is important that the drive shaft be longitudinally displaceable relative to the drive assembly once such positioning means have been removed.

The drive shaft, over its entire length, can have a substantially constant cross-sectional shape, which deviates from the circular shape, and the cross-sectional shape is preferably embodied as a hexagon, and the drive assembly has an opening that is penetrated by the drive shaft, and the opening is adapted to the drive shaft in such a way that the drive assembly is in form-locking rotary drive communication with the drive shaft. A drive shaft shaped in this way can be mass-produced and hence produced economically especially simply with the requisite linearity, in the form of long rods, and at the same time, the aforementioned longitudinal displaceability is assured. Moreover, the drive assembly can be adapted to the drive shaft especially simply; in particular, the appropriate internal contour is especially simple to produce by plastic injection molding.

The drive assembly can have a sleeve, whose inner circumferential surface forms the opening, and the second drive wheel is rotatably supported on the outside of the sleeve. The opening in the sleeve has a very large area of contact with the drive shaft, so that given the preferably form-locking force transmission, only slight compressive strains occur. Consequently, the sleeve can be injection-molded from plastic without any disadvantage, making the drive assembly especially economical. Moreover, a sleeve of only a comparatively slight wall thickness is necessary, since because of the large-area contact of the sleeve with the drive shaft, deformation thereof is largely precluded. Consequently, the drive assembly requires only little space. Because of the slight wall thickness, the second drive wheel provided on the outside of the sleeve is also weakened only slightly by the sleeve, in comparison to a drive wheel mounted directly on the drive shaft.

The sleeve can have a preferably one-piece flange, on which the second drive wheel is braced at least indirectly. This is intended to prevent foreign bodies, which would change the limit torque of the slip clutch, from getting between the sleeve and a second drive wheel. Preferably, the outer diameter of the flange and of the second drive wheel are embodied as substantially the same, making the penetration of foreign bodies even more difficult.

Between the flange and the second drive wheel, a separate first slide ring can be provided, which is Joined to the sleeve, preferably in a manner fixed against relative rotation. With this slide ring, a slide face for the second drive wheel is meant to be furnished but has especially high resistance to abrasion, so that the drive assembly has a long service life. The friction properties of the first slide ring thus define the limit torque of the slip clutch. The sleeve itself is protected against frictional stress, so that its material can be selected primarily for reasons of cost and strength. It is preferably considered that the sleeve should be made of polyamide (PA), which is optionally fiber-reinforced. The slide ring may for instance comprise polyoxymethylene (POM) or sintered metal. The connection, in a manner fixed against relative rotation, between the first slide ring and the sleeve is preferably brought about by form locking, so that the first slide ring can be easily installed. It is especially preferable to provide the substantially circular-cylindrical sleeve with a wrench face, to which the first slide ring is adapted.

The second drive wheel can be urged against the flange by a spring, preferably a helical spring, that surrounds the sleeve, and between the spring and the second drive wheel, a separate second slide ring is provided, which is joined to the sleeve in a manner fixed against relative rotation and longitudinally displaceably. It is known to generate the contact pressure of a slip clutch by means of a helical spring. This spring should surround the sleeve, thereby securely holding it in its position even if the drive assembly is not yet installed on the conveyor. To that end, a helical spring preferably surrounds a substantially circular-cylindrical sleeve with a slight spacing. The second slide ring is intended to provide that the spring will not rotate jointly with the second drive wheel, thereby averting unnecessary wear to the sleeve. The second slide ring is preferably embodied identically to the first slide ring, so that the production costs for the slide rings decrease. As a consequence, the second slide ring has the aforementioned favorable sliding properties of the first slide ring. The second slide ring, together with the first slide ring, defines the limit torque of the slip clutch.

The spring can be braced on a stop that is secured longitudinally adjustably to the sleeve. From the prior art, it is known to brace the spring on a stop. This stop should be secured longitudinally adjustably to the sleeve, so that the spring tension and thus the limit torque of the slip clutch can be set at the separate drive assembly, and typically no longer needs to be adjusted in the final installation of the conveyor.

The stop can have a female thread, which engages a male thread of the sleeve, and between the spring and the stop, a third slide ring is provided, which is joined to the sleeve in a manner fixed against relative rotation and longitudinally displaceably. With the threaded engagement between the sleeve and the stop, the longitudinal adjustment of the stop is furnished. The thread is preferably embodied as a fine screw thread, so that it is self-locking. The third slide ring is intended to prevent the rotary motion of the stop from being transmitted to the spring, which would prestress the spring in the direction of rotation and cause a corresponding restoring torque to be exerted on the stop. For cost reasons, the third slide ring is embodied identically to the first and/or second slide ring. To make it easier for the user to set the stop, a resilient, preferably one-piece detent lug on the stop may be provided, by which engagement with the aforementioned wrench face can be brought about. By means of this provision, every time the resilient detent lug sweeps over the wrench face, the user experiences a change in the torsion resistance of the stop. Thus the user receives tactile feedback upon each complete rotation of the stop and hence can very easily determine how much farther the stop still has to be rotated.

A separate bearing assembly can be provided, in which the drive assembly is rotatably supported, and the bearing assembly is detachably secured to the frame. By this provision, the bearing assembly together with the drive assembly can be preassembled as a unit on a mass-production basis, making its production especially economical. At the same time, this simplifies the final installation of the conveyor. Preferably, orientation means should be provided on the bearing assembly, which engage corresponding counterpart orientation means that are provided on the bearing of the associated feed roller, thus further simplifying the installation of the bearing assembly on the conveyor.

The drive shaft together with the drive assemblies and the separate bearing assemblies can be detachably secured as a unit to the frame. This assures that all the bearing assemblies, within the orientation play predetermined by the orientation and counterpart orientation means, can be secured to the frame in such a way that stress-free engagement with the drive shaft exists. Accordingly, no stresses that would reduce the service life of the rotary bearings occur in the rotary bearings of the drive assemblies. It has furthermore been demonstrated that the entire aforementioned unit can be installed markedly faster than the corresponding individual parts.

At least one positioning means, joined detachably to the drive shaft, can be provided, which defines the position of the drive shaft relative to an associated drive assembly. This provision is intended to prevent the drive shaft from shifting relative to the drive assemblies during operation. Preferably, the drive shaft is provided with small grooves, into which securing disks that act as positioning means are snapped, and the securing disks come to be in direct contact with the drive assembly. Because of the position of the grooves relative to the end of the drive shaft, the location of the connection point with a further drive shaft or with a drive can be defined to a standardized measure.

All the drive assemblies can be embodied identically, so that they can be produced on a mass-production basis and hence especially economically. This is easily possible because of the embodiment as a separate assembly. It should be pointed out that the spacing of the feed rollers does not affect the construction of a drive assembly, since each drive assembly is assigned its own rotary bearing. Thus the drive assembly need merely be adapted to an associated feed roller.

The axes of rotation of the feed rollers can be oriented perpendicular to the axis of rotation of the drive shaft, and the first and second drive wheels are bevel gear wheels. Although other embodiments, such as a drive shaft oriented obliquely to the feed rollers, or friction wheels instead of the gear wheels, are conceivable, the above embodiment has proved especially advantageous, including in conjunction with the separate drive module. What is decisive for this purpose is above all the fact that the driving engagement between the bevel gear wheels can be established and undone again without problems, so that the drive assembly can be installed especially simply.

The invention will be described in further detail below in conjunction with the drawings.

### BRIEF DESCRIPTION OF THE DRAWINGS

FIG. 1 is a perspective view of a modular portion of a rolling conveyor of the invention, which is equipped with a motor;

FIG. 2 is an exploded view of a modular portion of a rolling conveyor of the invention, which is not equipped with a motor;

FIG. 3 is a first exploded view of the second and third bearing assemblies with the drive assembly;

FIG. 3a is a second exploded view of the second and third bearing assemblies with the drive assembly of FIG. 3;

FIG. 4 is an exploded view of a drive assembly with the associated third bearing assembly;

FIG. 4a is cross section through the assembly of FIG. 4;

FIG. 5 is a perspective view of the receiving part;

FIG. 6 is an exploded view of a second bearing assembly, which is equipped with a third drive wheel;

FIG. 7 is a front view of the drive module of FIG. 1; and

FIG. 7a is an enlarged detail of FIG. 7 in the region of the drive shaft.

### DESCRIPTION OF THE PREFERRED EMBODIMENTS

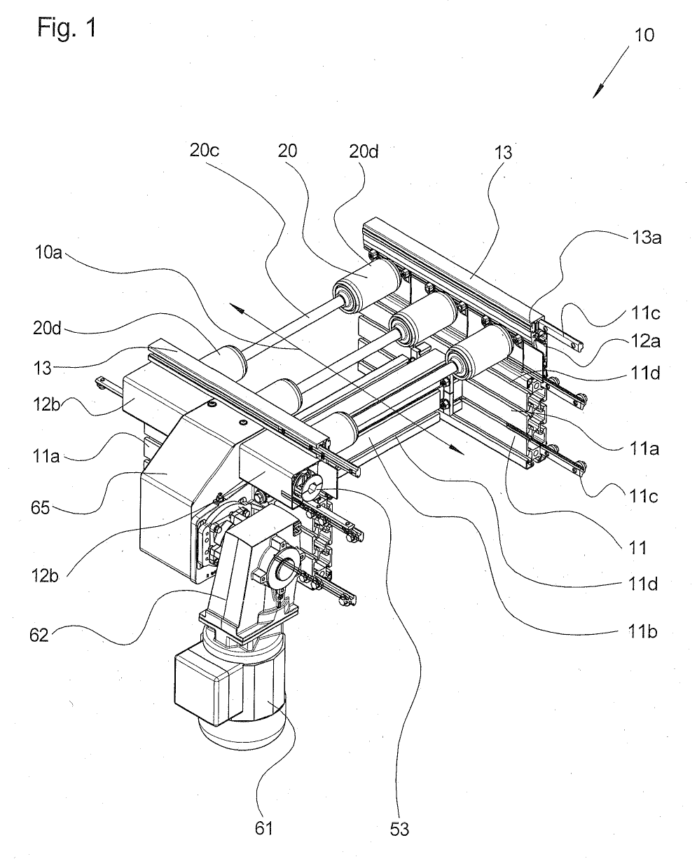

FIG. 1 shows a modular portion of a rolling conveyor 10, which, with further similar modules, is intended to form the entire conveyor route. Since this module is equipped with a motor 61 for driving the feed rollers 20, it is called a drive module.

The drive module includes a frame 11 with two parallel longitudinal beams 11a, which extend parallel to the conveying direction 10a and which are joined to one another via a transverse beam 11b. The longitudinal beams 11a and the transverse beam 11b are each extruded from aluminum, and on their outer surfaces a plurality of undercut, T-shaped grooves 11d are provided, to which other components can be secured at different, continuously variable positions. On the face ends of the longitudinal beams 11a, a plurality of connection strips 11c are received in the undercut grooves, and with these connection strips, adjoining modules of the rolling conveyor can be fixedly joined together.

On the top side of the longitudinal beams 11a, a plurality of parallel feed rollers 20 are each rotatably supported on both ends. The feed rollers each include a steel roller shaft 20c, on each of whose two end regions a respective contact portion 20d is provided that has a circular-cylindrical plastic surface. The contact portions 20d define a flat conveyor surface, in which the product being conveyed, in the form of a platelike workpiece holder (not shown), can be moved. Laterally, the conveyor surface is bounded by two lateral guide strips 13, which are provided with a replaceable friction lining 13a of plastic, along which the workpiece holders slide. The lateral guide strips 13 are likewise extruded from aluminum.

On a side face of one longitudinal beam 11a, an electric motor 61 is provided, which is in rotary drive communication with a drive shaft, via a gear drive 62 and a toothed belt drive. Since the drive shaft is covered by a covering 12b, all that can be seen of the drive shaft in FIG. 1 is the claw clutch 53 on its end, with which the rotary drive communication with the drive shaft of the adjacent module of the rolling conveyor is established. The transmission of force from the drive shaft to the feed rollers 20 will be described in further detail hereinafter. The toothed belt drive cannot be seen in FIG. 1, either, since for safety reasons it is covered by the belt covering 65. The covering 12a on the side diametrically opposite the drive shaft should also be pointed out. The two coverings 12a and 12b are each extruded from aluminum and are substantially U-shaped in cross section, differing only with regard to the length of the legs of the U.

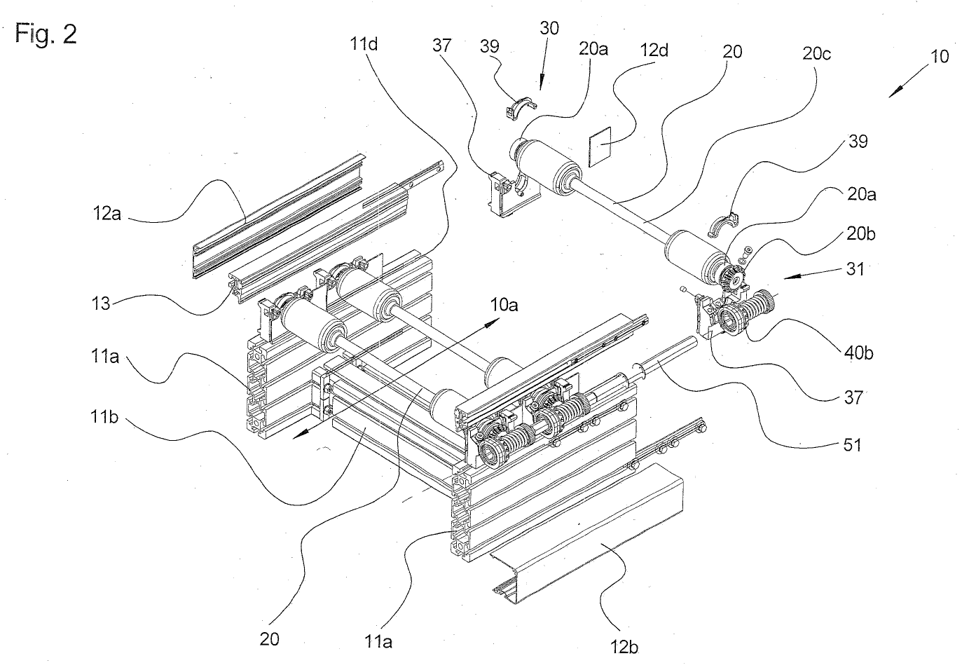

FIG. 2 shows a further module of the rolling conveyor 10 of the invention, which is not equipped with a drive motor. It is therefore also called a system module. The system module of FIG. 2, except for the lack of the drive, is embodied identically to the drive module of FIG. 1. Accordingly, identically embodied parts are provided with the same reference numerals. With respect to the identical parts, see the above description, to avoid repetition.

In FIG. 2, the feed rollers 20 are each equipped with a first drive wheel 20b, in the form of a bevel gear wheel, which is secured directly to the roller shaft 20c in a manner fixed against relative rotation. A second drive wheel 40b, which is likewise embodied as a bevel gear wheel, is associated with each first drive wheel 20b. To assure gear wheel engagement with little noise or wear, the first drive wheel 20b comprises polyoxymethylene (POM), while the second drive wheel 40b is a polyamide (PA) or sintered metal, or vice versa. Every second drive wheel 40b is disposed on a common drive shaft 51, which has the same length as the associated module of the rolling conveyor 10. The rotary drive engagement between the second drive wheels 40b and the drive shaft 51 will be addressed in further detail hereinafter. The drive shaft 51 is oriented precisely perpendicular to the associated parallel feed rollers 20, and the axes of rotation each intersect at a point.

The rotary bearing of the feed rollers 20 is accomplished by providing that on each of the two end regions of the feed roller 20 on the roller shaft 20c, a respective rotary bearing 20a is provided, in the form of a radial deep groove ball bearing provided with lifetime lubrication. The rotary bearings 20a are each received in a separate receiving part 37, which can be secured in any arbitrary position with regard to the conveying direction 10a at an undercut groove 11d of the longitudinal beam 11a. The two receiving parts 37 that are associated with one feed roller 20 are each embodied identically and are located 180° away from one another. Between two adjacent receiving parts 37, one platelike closure part 12d is provided, so that the receiving parts 37 with the associated closure parts 12d form a closed wall, each of which, together with the coverings 12a or 12b, enclose a substantially completely closed-off space in which the associated bearing and drive components are received in a way protected against environmental factors.

It should also be pointed out that the second bearing assembly 31 is formed by the receiving part 37 on the side of the drive shaft 51, the associated rotary bearing 20a, and the corresponding retention part 39. The first bearing assembly 30 is formed by the corresponding parts on the diametrically opposite side of the feed roller 20.

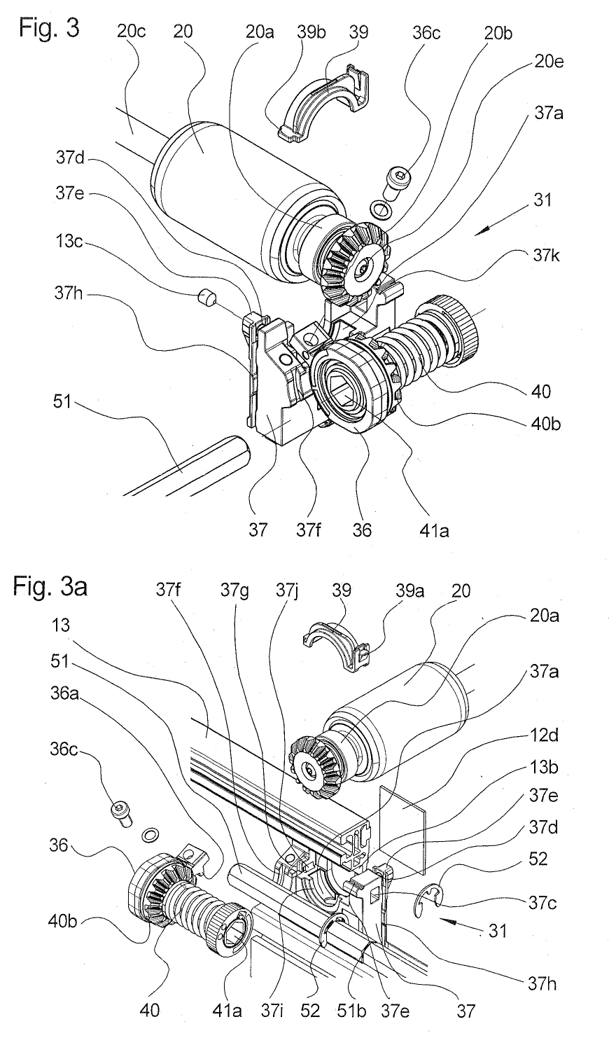

FIG. 3 shows an enlarged detail of FIG. 2, with the second bearing assembly 31, the third bearing assembly 36, and the drive assembly 40. FIG. 3a shows the same arrangement from a different direction.

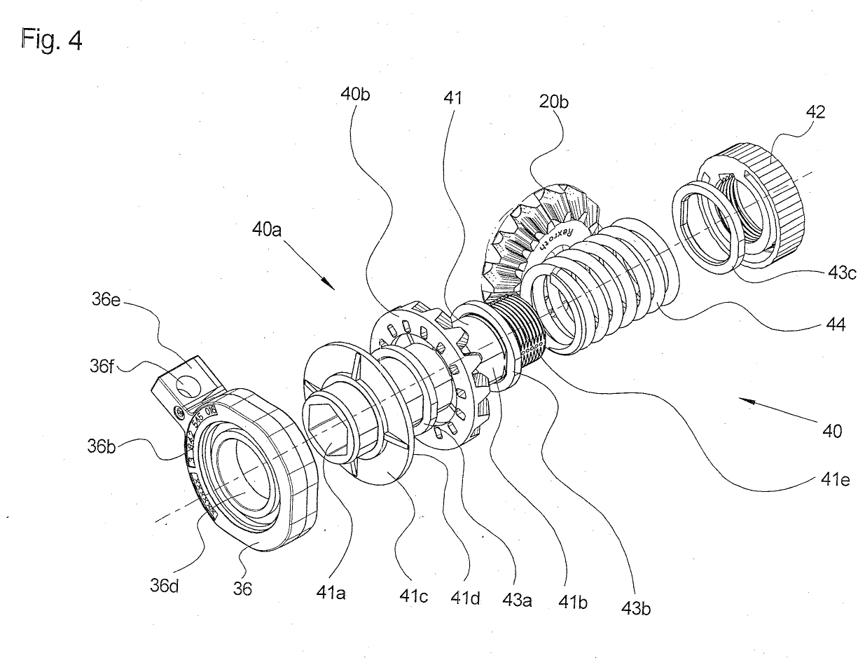

The drive assembly 40 having the second drive wheel 40b is joined detachably, via the third bearing assembly 36, to the receiving part 37 of the second bearing assembly 31, and the aforementioned assemblies are secured to one another via the screw bolt 36c. A groove 37f is provided on the receiving part 37 and is engaged by an adapted orientation extension (36g in FIG. 4a) on the third bearing assembly 36 for the sake of mutual orientation. The groove 37f extends in the circular arc about the axis of rotation of the drive shaft 51, so that the third bearing assembly 36 can be rotated freely about the aforementioned axis of rotation, even when the drive shaft 51 is already in its installation position. On the third bearing assembly 36, a hook 36a is provided, which can catch in a suitable recess 37g on the receiving part 37. In the installation of the rolling conveyor, accordingly first the third bearing assemblies 36 with the associated drive assemblies 40 are slipped onto the drive shaft 51, producing a drive shaft assembly. The drive assembly is provided for that purpose with a hexagonal opening 41a, which is adapted to the hexagonal cross-sectional shape of the drive shaft 51 in such a way that on the one hand a form-locking rotary drive communication and at the same time the desired longitudinal displaceability between the drive assembly 40 and the drive shaft 51 are brought about.

The aforementioned drive shaft assembly is now caught with the aid of the hook 36a in the corresponding receiving parts 37, so that it is retained in the desired final installed position. Normally, a sufficient hold is achieved is achieved if only two hooks 36a, which are on the ends relative to the drive shaft 51, are caught. The third bearing assemblies 36 can now be rotated into their installation position about the axis of rotation of the drive shaft 51 and screwed to the associated receiving parts 37. Once this work is concluded, the position of the drive shaft, which is longitudinally displaceable relative to the drive assembly 40, is secured with positioning means, in the form of two securing disks 52. The securing disks 52 are snapped for that purpose into corresponding grooves 51b that are provided on the drive shaft 51, and the drive shaft 51 is equipped with a plurality of such grooves, whose locations are adapted to the predetermined spacing dimensions of the feed rollers 20.

In FIGS. 3 and 3a, the grooves 37h for receiving the platelike closure parts 12d can also be seen. The receiving grooves 37d for receiving the securing rib 13b of the lateral guide 13 can also be seen, which are provided on the face ends of the legs of the of the qenerally U-shaped receiving part 37. The lateral guide 13 is secured in these receiving grooves 37d with the aid of the threaded pins 13c. The associated female-threaded portion on the receiving part 37 simultaneously acts as a counterpart detent means 37e for corresponding detent means at coverings (not shown) between the feed rollers 20. The detent lugs 37k for the lateral coverings (12a and 12b in FIG. 2) should also be pointed out. The receiving part 37 is made from aluminum by diecasting, so that the many securing contours can be furnished economically.

Also in FIGS. 3 and 3a, the receiving recess 37a of the receiving part 37 for receiving the rotary bearings 20a at the feed roller 20 can be seen. The receiving recess 37a is provided with rims 37i on both sides, which prevent shifting of the rotary bearing in the direction of the axis of rotation of the associated feed roller 20. The opening in the receiving recess 37a is closed by a retention part 39 of plastic, which is a continuation of the aforementioned receiving contours for the rotary bearing 20a on the receiving part 37 to the shape of a full circle. The retention part is provided with an elastic snap hook 39a, which is snapped into an adapted opening 37c. On the diametrically opposite side, the retention part 39 is provided with a substantially rigid retention extension 39b, which engages an adapted recess 37j in such a way that the retention part 39 can be tilted by at least 30° relative to the receiving part 37, making simple installation of the retention part 39 possible. The first drive wheel 20b is secured to the roller shaft 20c with a securing screw 20e, and two wrench faces (not visible) are provided on the face end of the roller shaft 20c and bring about a form-locking engagement between the first drive wheel 20b and the associated roller shaft 20c.

FIG. 4 is an exploded view of the drive assembly 40 with the associated third bearing assembly 36. FIG. 4a shows the aforementioned assemblies in cross section.

The third bearing assembly 36 includes a basic component 36b of diecast aluminum, with a built-in radial deep groove ball bearing 36d with lifetime lubrication, as a rotary bearing for the drive assembly 40. A securing extension 36e with a securing bore 36f for the aforementioned screw bolt (36c in FIG. 3) is located on the basic component 36b. The orientation extension 36g, visible in FIG. 4a, should also be mentioned, which engages the groove (37f in FIG. 3) of the receiving part.

The drive assembly 40 includes a substantially circular-cylindrical sleeve 41, which is injection-molded from fiber-reinforced polyamide. On the inside of the sleeve, an opening 41a with a hexagonal cross section is provided, which is adapted to the drive shaft such that the sleeve 41 is displaceable on the drive shaft longitudinally, and at the same a form-locking rotary drive communication is provided. On the outer circumferential surface of the sleeve 41, a flange 41c is provided integrally, on the left-hand side of which, in FIG. 4, the rotary bearing 36d is mounted on the sleeve 41 in such a way that the drive assembly 40 can be installed as a unit in the third bearing assembly 36. The right-hand side face of the flange in terms of FIG. 4 serves as a friction face 41d for the second drive wheel 40b, which rests slidingly on this face and is prestressed against it by the helical spring 44, forming a slip clutch 40a.

A total of three identical slide rings 43a, 43b and 43c of polyoxymethylene (POM) or sintered metal are provided on the outer circumferential surface of the sleeve 41 and are retained on the sleeve 41 longitudinally displaceably and in a manner fixed against relative rotation via two diametrically opposed wrench faces 41b. The first slide ring 43a serves primarily as a radial bearing for the second drive wheel 40b that is rotationally movable relative to the sleeve 41. The second slide ring 43b is intended to prevent the spring 44 from being slaved by the rotating second drive wheel 40b, so that it is always still relative to the sleeve 41. The third slide ring 43c prevents the transmission of a rotary motion of the stop 42 to the spring 44. The stop 42 is in helical engagement with a male thread 41e on the sleeve 41, so that by rotation the stop can be shifted longitudinally relative to the sleeve 41, thereby prestressing the spring 44 against the second drive wheel 40b. The male thread 41e is a fine screw thread, so that it is self-locking in order that the stop 42 will not come loose on its own.

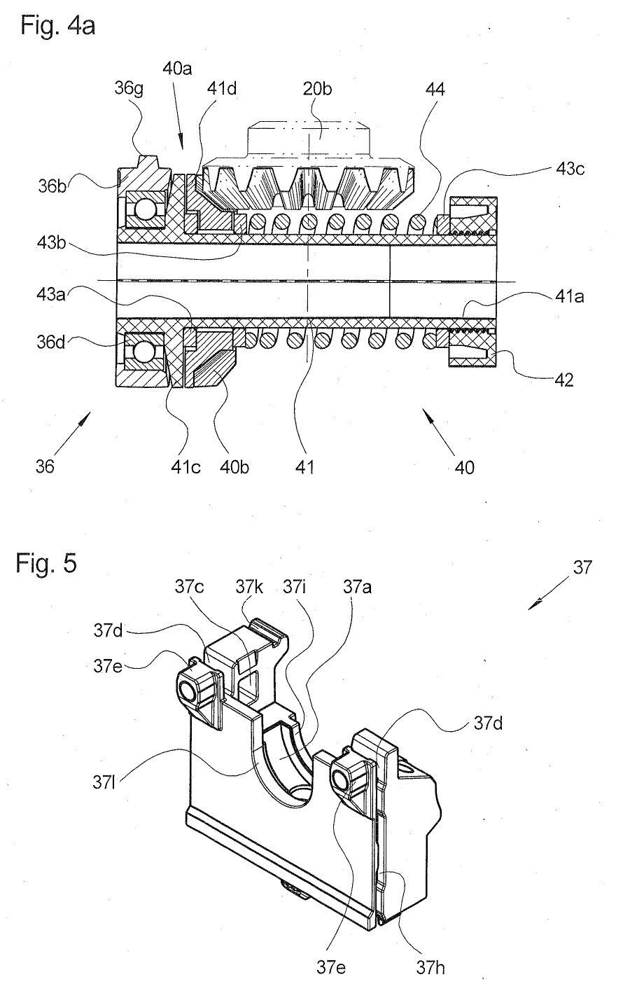

FIG. 5 shows a perspective view of the receiving part 37 from the opposite direction compared to FIGS. 3 and 3a. At this point, all that needs to be pointed out is the U-shaped recess 371, which is adapted to the axis of the feed roller with a slight spacing, so that the rotary bearing located behind it is well protected against environmental factors. For the rest, see the description of FIGS. 3 and 3a, to avoid repetition.

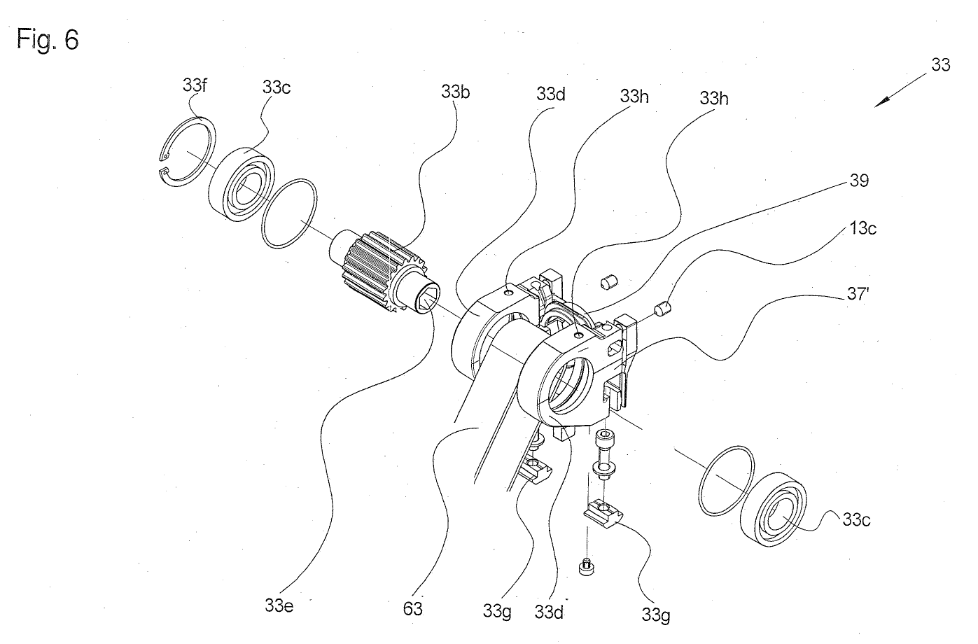

FIG. 6 shows a second bearing assembly 33, which is equipped with a third drive wheel 33b. With regard to the bearing of the feed roller (not shown) and the securing of the adjoining components, this bearing assembly 33 is embodied precisely like the second bearing assembly (31 in FIGS. 3 and 3a) that is not provided with a third drive wheel, so that in this respect, reference is made to the description above.

The third drive wheel 33b serves to drive the drive shaft (51 in FIG. 2). For that purpose, it is connected to an electric motor (not shown) via a tension means 63 in the form of a toothed belt. The rotary drive communication with the drive shaft, as is the case for the drive assembly (40 in FIG. 4), is established via a hexagonal opening 33e in the third drive wheel 33b, so that the third drive wheel 33b is joined to the drive shaft by form locking in a manner fixed against relative rotation, and at the same time, for the sake of simple installation, the drive shaft is longitudinally displaceable relative to the third drive wheel 33b.

The third drive wheel 33b is located in a rectilinear extension of the feed roller, in the region where the second drive wheel is normally located. Two bearing flanges 33d are integrally provided on the receiving part 37 for this purpose. In each of the two bearing flanges 33d, a respective rotary bearing 33c in the form of a radial deep groove ball bearing with lifetime lubrication is received, in which the third drive wheel 33b and thus the drive shaft are rotatably supported. The two-sided bearing of the third drive wheel 33b is necessary so that the rotary bearing withstands the tensile forces resulting from the tension of the toothed belt 63 over a sufficiently long period of time. The assembly comprising the third drive wheel 33b and the two associated rotary bearings 33c is held in the second bearing assembly 33 by the securing ring 33f. With the two sliding blocks 33g, the second bearing assembly 33 is secured to the undercut grooves in the associated longitudinal beam. The two securing threads 33h serve to secure the belt covering (65 in FIG. 1).

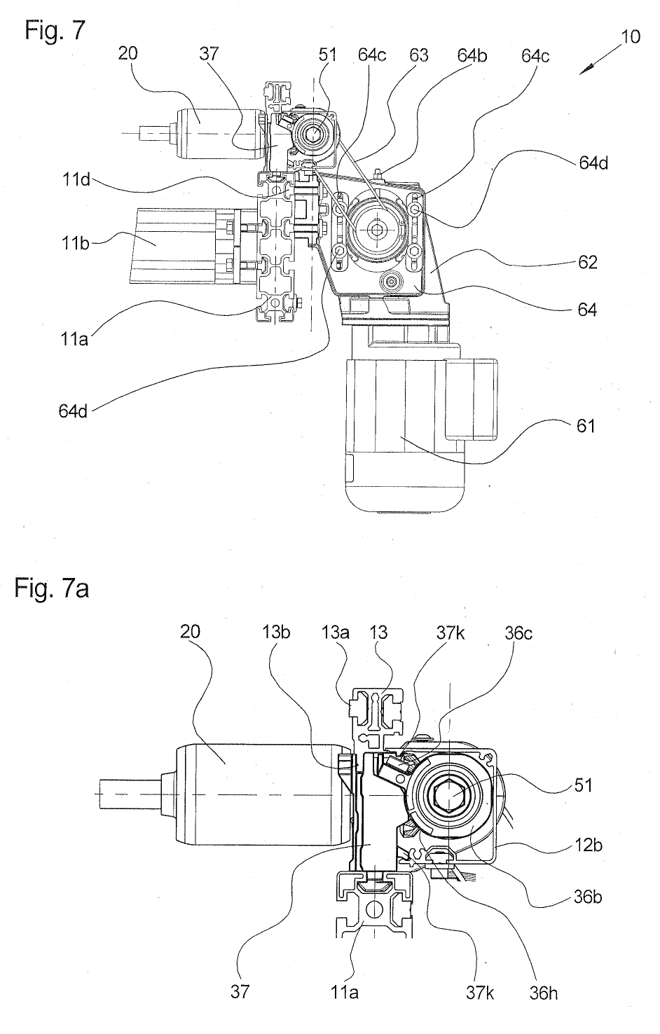

FIG. 7 shows a front view of the drive module of FIG. 1, with the belt covering (65 in FIG. 1) removed. The motor flange 64 can be seen, with which the electric motor 61 and the gear mechanism 62 are secured to the undercut grooves 11d in the longitudinal beam 11a. For the fixation of the location of the motor flange 64 on the longitudinal beam 11a, the latter is displaced in the conveying direction until such time as it abuts against the associated second bearing assembly on the receiving part 37. These components and the motor 61 are adapted to one another in such a way that in this position, the toothed belt 63 is oriented precisely perpendicular to the axis of rotation of the drive shaft 51. The motor flange 64 is equipped with two oblong slots 64c, so that the motor 61 can be secured to the motor flange 64 in different positions. With the aid of the setting screw 64b, the motor 61 is displaced into the position in which the toothed belt 63 has the appropriate tension. The motor 61 is then screwed firmly to the motor flange 64 by means of the securing screws 64d.

FIG. 7a is an enlarged detail of FIG. 7 in the region of the hexagonal drive shaft 51. It can be seen in particular from this view how the U-shaped covering 12b is snapped into the associated detent lugs 37k on the receiving part 37. The lateral guide strip 13 can also be seen, with the friction lining 13a received in it that protrudes somewhat past the lateral guide strip 13, so that the associated workpiece holder (not shown) is in sliding contact with only the friction lining 13a. It is also shown how the lateral guide strip 13 is inserted with its securing rib 13b into the receiving part 37. The basic component 36b with its outer circumferential surface 36h that is concentric with the drive shaft 51 should also be pointed, which makes it possible to rotate the third bearing assembly relative to the drive shaft 51, with the screw bolt 36c removed, in the course of which the outer circumferential surface 36h simultaneously acts as a contact face for the receiving part 37.

It will be understood that each of the elements described above, or two or more together, may also find a useful application in other types of constructions differing from the types described above.

While the invention has been illustrated and described as embodied in a rolling conveyor with a separate drive assembly, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A rolling conveyor, comprising a frame; a plurality of feed rollers supported on said frame and defining a conveyor surface, at least some of said feed rollers each having a first drive wheel which is in rotary drive communication with a second drive wheel, said second drive wheels being located on a rotatable drive shaft with which they are each in rotary drive communication via a respective slip clutch, at least one of said second drive wheels and an associated slip clutch being combined each into a separate drive assembly that is installable as a unit, said drive assembly being supported rotatably on said frame, and said drive shaft being received in said drive assembly in a manner fixed against relative rotation.

2. The rolling conveyor as defined in claim 1, wherein all said second drive wheels and said associated slip clutch are combined each into said separate drive assembly.

3. The rolling conveyor as defined in claim 1, wherein said drive shaft is received in said drive assembly in the manner fixed against relative rotation and also longitudinally displaceably.

4. The rolling conveyor as defined in claim 1, wherein said drive shaft, over its entire length, has a substantially constant cross-sectional shape which deviates from a circular shape, said drive assembly having an opening that is penetrated by said drive shaft, and said opening being adapted to said drive shaft in such a way that said drive assembly is in form-locking rotary drive communication with said drive shaft.

5. The rolling conveyor as defined in claim 4, wherein said drive shaft has the substantially constant cross-sectional shape which is configured as a hexagon.

6. The rolling conveyor as defined in claim 4, wherein said drive assembly has a sleeve whose inner circumferential surface forms the opening, said second drive wheel being rotatably supported on an outside of said sleeve.

7. The rolling conveyor as defined in claim 6, wherein said sleeve has a flange on which said second drive wheel is braced.

8. The rolling conveyor as defined in claim 7, wherein said flange of said sleeve is a one-piece flange, said second drive wheel being braced on said one-piece flange indirectly.

9. The rolling conveyor as defined in claim 7, wherein between said flange and said second drive wheel a separate first slide ring is provided which is joined to the sleeve.

10. The rolling conveyor as defined in claim 9, wherein said separate first slide ring is jointed to said sleeve in a manner fixed against relative rotation.

11. The rolling conveyor as defined in claim 9, wherein said second drive wheel is urged against said flange by a spring that surrounds said sleeve, and between said spring and said second drive wheel a separate second slide ring is provided, which is joined to said sleeve in a manner fixed against relative rotation and longitudinally displaceably.

12. The rolling conveyor as defined in claim 1, wherein said spring is configured as a helical spring.

13. The rolling conveyor as defined in claim 11, wherein said spring is braced on a stop that is secured longitudinally adjustably to said sleeve.

14. The rolling conveyor as defined in claim 13, wherein said stop has a female thread which engages a male thread on said sleeve, and between said spring and said stop a third slide ring being provided, which is joined to said sleeve in a manner fixed against relative rotation and longitudinally displaceably.

15. The rolling conveyor as defined in claim 14, wherein a slide ring selected from the group consisting of said first slide ring, said second slide ring, said third slide ring, and a combination thereof are configured identically.

16. The rolling conveyor as defined in claim 1, wherein a separate bearing assembly is provided, in which said drive assembly is rotatably supported, said bearing assembly being detachably secured to said frame.

17. The rolling conveyor as defined in claim 16, wherein said drive shaft together with said drive assemblies and said separate bearing assembly is detachably secured as a unit to said frame.

18. The rolling conveyor as defined in claim 1, wherein at least one positioning means, joined detachably to said drive shaft, is provided, said at least on positioning means defining a position of said drive shaft relative to an associated drive assembly.

19. The rolling conveyor as defined in claim 1, wherein all said drive assemblies are configured identically.

20. The rolling conveyor as defined in claim 1, wherein axes of rotation of said feed rollers are oriented perpendicular to an axis of rotation of said drive shaft, said first and second drive wheels being bevel gear wheels.
